(19) United States
(12) Patent Application Publication
(10) Pub. No.: US 2018/0099733 A1
(43) Pub. Date: Apr. 12, 2018

(54) UNDERWATER MOBILE BODY AND UNDERWATER COMMUNICATION SYSTEM

(71) Applicant: FUJI XEROX CO., LTD., Tokyo (JP)

(72) Inventors: Masahiro SATO, Kanagawa (JP); Motofumi BABA, Kanagawa (JP); Tsutomu KIMURA, Kanagawa (JP); Yoshihiko NEMOTO, Kanagawa (JP); Akihito YAMAUCHI, Kanagawa (JP); Kengo TOKUCHI, Kanagawa (JP)

(73) Assignee: FUJI XEROX CO., LTD., Tokyo (JP)

(21) Appl. No.: 15/583,297

(22) Filed: May 1, 2017

(30) Foreign Application Priority Data
Oct. 6, 2016 (JP) 2016-198245

(51) Int. Cl. B63G 8/00; H04B 13/02

(52) U.S. Cl. CPC B63G 8/001; B63G 2008/004; H04B 13/02

(57) ABSTRACT

An underwater mobile body include: a communication unit that performs underwater wireless communication with a relay device; a detection unit that detects a state of wireless communication between the relay device and the underwater mobile body; and a control unit that controls a positional relationship between the relay device and the underwater mobile body so that a result of detection by the detection unit satisfies a predetermined criterion.

### CROSS-REFERENCE TO RELATED APPLICATIONS

This application is based on and claims priority under 35 USC 119 from Japanese Patent Application No. 2016-198245 filed Oct. 6, 2016.

### BACKGROUND

### Technical Field

The present invention relates to an underwater mobile body and an underwater communication system.

### SUMMARY

According to an aspect of the invention, there is provided an underwater mobile body including: a communication unit that performs underwater wireless communication with a relay device; a detection unit that detects a state of wireless communication between the relay device and the underwater mobile body; and a control unit that controls a positional relationship between the relay device and the underwater mobile body so that a result of detection by the detection unit satisfies a predetermined criterion.

### BRIEF DESCRIPTION OF THE DRAWINGS

Exemplary embodiments of the present invention will be described in detail based on the following figures, wherein:

FIG. 1 is a diagram illustrating a configuration example of an underwater drone used in this exemplary embodiment;

FIG. 2 is a block diagram illustrating an example of a functional configuration of a controller according to this exemplary embodiment;

FIG. 3 is an illustration conceptually showing the movement control performed by a movement controller according to this exemplary embodiment;

FIG. 4 is a flowchart illustrating an example of processing steps executed by the movement controller according to this exemplary embodiment;

FIG. 5 is an illustration for explaining an example in which communication is relayed between an underwater drone and a base station via a buoy;

FIG. 6 is an illustration for explaining another example in which communication is relayed between an underwater drone and a base station via a buoy;

FIG. 7 is an illustration for explaining an example in which communication is relayed between an underwater drone and a base station via a relay station coupled to the base station by a cable;

FIG. 8 is an illustration showing an example in which a relay device is an underwater mobile body;

FIG. 9 is an illustration showing an operation example when each of underwater drones serving as relay devices has the internal configuration of an underwater drone serving as a terminal;

FIG. 10 is an illustration showing an example in which an underwater drone serving as a relay device approaches the underwater drone serving as a terminal;

FIG. 11 is an illustration for explaining a case where multiple candidates for a communication destination are present as an object to be controlled as to positional relationship;

FIG. 12 is a flowchart illustrating an example of steps executed for determining a communication destination by the movement controller according to this exemplary embodiment;

FIG. 13 is an illustration for explaining a function provided in case communication becomes impossible; and

FIG. 14 is a flowchart illustrating an example of processing steps executed by the movement controller for recovering communication.

### DETAILED DESCRIPTION

Hereinafter, exemplary embodiments of the present invention will be described in detail with reference to the accompanying drawings.

### First Embodiment

### <Configuration of Underwater Drone>

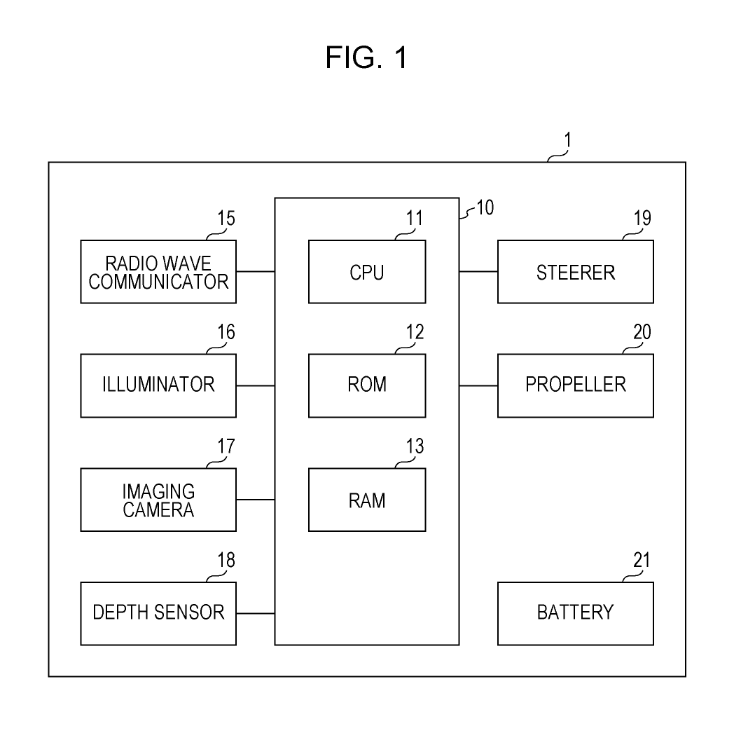

FIG. 1 is a diagram illustrating a configuration example of an underwater drone 1 according to a first exemplary embodiment. The underwater drone 1 is an example of an underwater mobile body, and more specifically, is a type of unmanned underwater mobile body. The underwater drone is classified into an autonomous navigation type and a remote-control type. In this exemplary embodiment, the underwater drone is assumed to be remote-control type. However, the details of the control described later may be applied to an autonomous navigation underwater drone.

Functional units configurating the underwater drone 1 are connected to a controller 10 which is as an example of the control unit. The functional units including the controller 10 are basically housed in a housing which adopts a waterproof structure. Power is supplied from a battery 21 to the functional units including the controller 10. The battery 21 is an example of a power source, and uses, for instance, a primary battery, a secondary battery and/or a fuel cell. It is to be noted that an internal combustion engine may be used as the power source.

The controller 10 controls the units that configurate the underwater drone 1. The controller 10 is configurated by a central processing unit (CPU) 11, a read only memory (ROM) 12, and a random access memory (RAM) 13. The ROM 12 stores programs to be executed by the CPU 11. The CPU 11 reads a program stored in the ROM 12, and executes the program using the RAM 13 as a work area. The CPU 11 controls the functional units that configurate the underwater drone 1 by the execution of the program.

In the case of this exemplary embodiment, the underwater drone 1 is equipped with a radio wave communicator 15 as an example of the communication unit. The radio wave communicator 15 transmits and receives radio waves, and performs wireless communication with another communication device under water. In the case of this exemplary embodiment, the underwater drone 1 is used as one of terminals. A communication device serving as the other terminal is normally provided on water or land, however may be provided under water. For instance, the other terminal may be mounted on the inside of an underwater mobile body other than the underwater drone 1.

The radio wave communicator 15 in this exemplary embodiment uses radio waves with a wavelength of 10 km or longer and 100 km or shorter, called very low frequency radio waves for communication. The very low frequency radio waves reach a water depth of approximately 10 m. It is to be noted that when radio waves with a wavelength of 100 km or longer and 1,000 km or shorter, called extremely low frequency radio waves is used for communication, the radio waves reach a water depth of approximately 100 m. However, the transmission distance varies depending on whether communication is performed in fresh water or sea water, and is affected by the presence of wave on the surface of water, the presence of turbidity and a water temperature.

An illuminator 16 is provided to illuminate an operating range. As the illuminator 16, for instance, a halogen lamp, a white light emitting diode (LED) or a color LED is used. An imaging camera 17 is provided to capture an image of the operating range. The imaging camera 17 may be a camera that captures a still image or a camera that captures a dynamic image. A captured image is stored in the RAM 13, for instance.

A depth sensor 18 detects a depth utilizing a water pressure. The depth sensor 18 converts a detected water pressure to a depth, and outputs the depth to the controller 10. The accuracy of measurement of and resolution of the depth depend on the depth sensor 18.

A steerer 19 is used to change the direction of movement. The direction of movement is controlled by remote control or a program executed by the controller 10. The direction of movement includes not only a direction in a horizontal plane, but also a vertical direction (a surfacing direction and a descending direction). A propeller 20 is configurated by, for instance, a propeller and a motor that rotates the propeller. The motor has a watertight structure to protect the inside from rusting. The steerer 19 and the propeller 20 are examples of a drive unit.

<Functional Configuration of Controller>

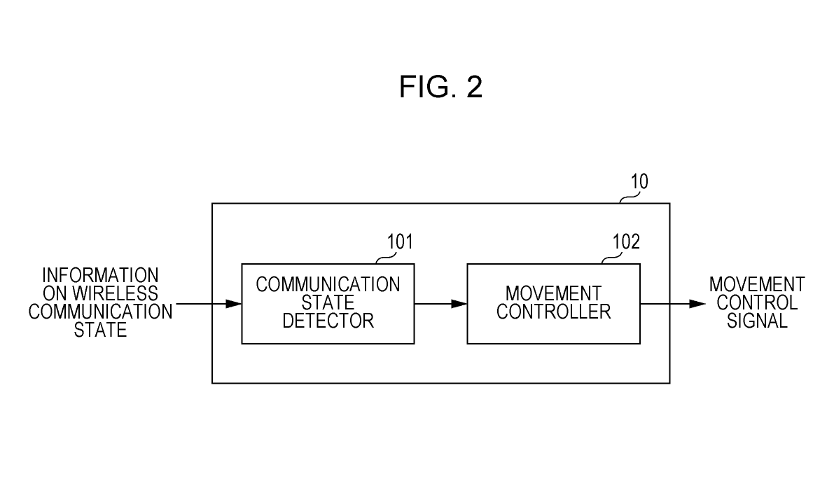

Next, the functional configuration of the controller 10 will be described. FIG. 2 is a block diagram illustrating an example of the functional configuration of the controller 10 according to the first exemplary embodiment. The controller 10 has a communication state detector 101 and a movement controller 102. The communication state detector 101 is an example of the detection unit, and the movement controller 102 is an example of the control unit.

The communication state detector 101 detects a state of wireless communication between the underwater drone 1 and another communication device. For this reason, the communication state detector 101 receives input of information such as a transmission speed, an intensity of received radio waves, a retransmission rate, the number of disconnection and an error ratio. These pieces of information are measured or calculated by the radio wave communicator 15, for instance. It is to be noted that the transmission speed is calculated as the amount of data exchanged per unit of time between the radio wave communicator 15 and another communication device.

The communication state detector 101 evaluates these pieces of information, and outputs an evaluation value as a result of the detection of the state of wireless communication. The evaluation here may be evaluation for each piece of information or comprehensive evaluation based on a result of evaluation of individual pieces of information. The evaluation value is expressed, for instance, as a “favorable state”, an “average state” or an “unfavorable state”. In this exemplary embodiment in which very low frequency radio waves are used for wireless communication, when the communication distance approaches 10 m and the communication state has become worse, the evaluation value is an “unfavorable state”.

The movement controller 102 controls the positional relationship between the underwater drone 1 and another communication device based on the result of detection given from the communication state detector 101. For instance, when the result of detection is an “unfavorable state”, the movement controller 102 performs control to decrease the distance between the underwater drone 1 and another communication device so as to achieve a “favorable state” or an “average state”.

In the case of this exemplary embodiment, a “favorable state” or “average state” is an example of a state satisfying the predetermined criterion, and an “unfavorable state” is an example of a state not satisfying the predetermined criterion. It is to be noted that the example of a state not satisfying the predetermined criterion may include a state where communication is impossible temporarily.

In the case of this exemplary embodiment, when the evaluation value does not satisfy the criterion, the movement controller 102 controls the movement so that the underwater drone 1 comes closer to another communication device. In other words, the movement controller 102 moves the underwater drone 1 in a direction in which the state of wireless communication is better than the current state. An example of a method of determining a movement direction is presented below.

For instance, the movement controller 102 reads a movement path of the underwater drone 1 from the RAM 13, and causes the underwater drone 1 to move along the movement path. Alternatively, for instance, the movement controller 102 reads the direction of movement of the underwater drone 1 from the RAM 13, and causes the underwater drone 1 to move in the direction opposite to the read direction.

Alternatively, for instance, the movement controller 102 causes the underwater drone 1 to directly move to a position at which the intensity of received radio waves is high, based on the relationship stored in the RAM 13 between the movement path and the intensity of received radio waves. Alternatively, for instance, the movement controller 102 determines a direction in which the underwater drone 1 comes closer to the position of another communication device, utilizing a navigation system configurated by an underwater beacon and the like. Alternatively, for instance, the movement controller 102 causes the underwater drone 1 to move in a direction in which the intensity of measured received radio waves increases. Alternatively, for instance, when the position of another communication device is known, the movement controller 102 causes the underwater drone 1 to move to the position.

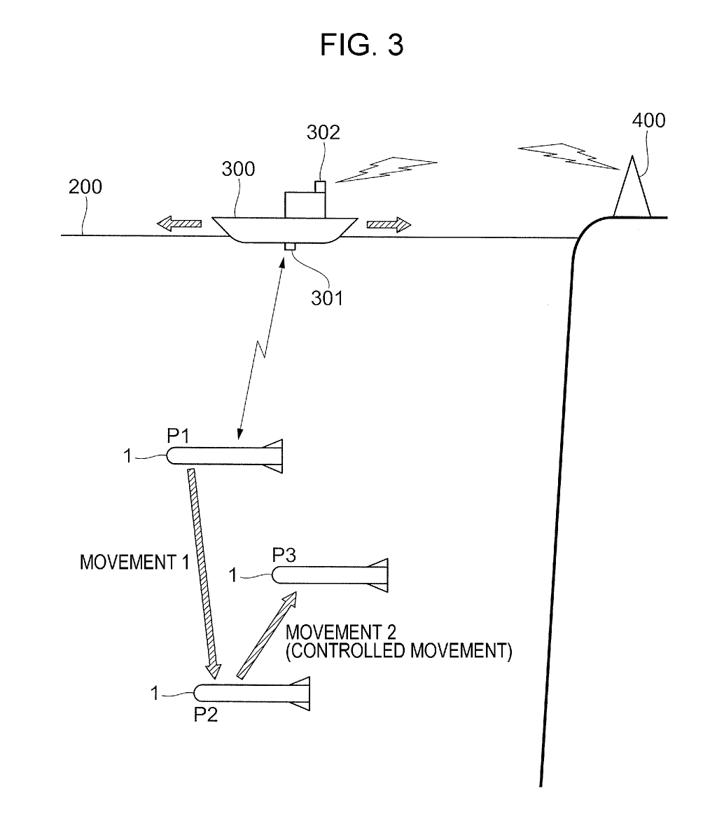

Here, an example of an operation achieved by the movement controller 102 will be described using the drawings. FIG. 3 is an illustration conceptually showing the movement control performed by the movement controller 102 according to this exemplary embodiment. FIG. 3 illustrates an example in which the underwater drone 1 communicates with a base station 400 via a ship 300 which moves along a water surface 200. A communication device 301 for wireless communication is mounted on the bottom of the ship 300, and a communication device 302 for aerial communication is mounted on the ship 300. The communication device 301 and the underwater drone 1 configurate an underwater communication system.

The communication devices 301 and 302 are coupled to each other via a communication path which is not illustrated. In the case of this exemplary embodiment, the communication device 301 performs wireless communication underwater with the underwater drone 1 using very low frequency radio waves. In addition, the communication device 302 performs wireless communication in air with the base station 400 using radio waves shorter than very low frequency radio waves. For this reason, the communication device 301 functions as a relay device that relays communication between the underwater drone 1 and the base station 400.

The underwater drone 1 moves freely underwater under remote control or in accordance with an installed program. FIG. 3 illustrates “movement 1” which indicates the situation where the underwater drone 1 at a position P1 moves to a position P2 away from the ship 300 (communication device 301) in a depth direction. When the position P2 is at a water depth of 10 m, wireless communications via radio wave between the underwater drone 1 and the communication device 301 is difficult. Specifically, the intensity of the radio wave received by the underwater drone 1 falls below a criterion value, and the transmission speed also falls below a criterion value.

In this case, the movement controller 102 determines that the evaluation value given from the communication state detector 101 has failed to satisfy the criterion. Then, the movement controller 102 commands the underwater drone 1 to move closer to the ship 300 (communication device 301). Specifically, the movement controller 102 controls the steerer 19 and the propeller 20, and causes the underwater drone 1 to surface. In FIG. 3, this movement is indicated by “movement 2”. The distance between the underwater drone 1 and the ship 300 which has moved to the position P3 is shorter than the distance between the underwater drone 1 and the ship 300 at the position P2. Then, the intensity of the radio waves received by the underwater drone 1 exceeds a criterion value, and the transmission speed also exceeds a criterion value. Consequently, the underwater drone 1 is again in a state that allows high-speed communication with the communication devices 301.

It is to be noted that factors to worsen the state of wireless communication may include not only the communication distance, but also change in the underwater temperature, the tidal current, and other environments. Anyway, when the state of wireless communication has worsened, the movement controller 102 causes the underwater drone 1 to move closer to the communication device 301 which is a communication partner to improve communication quality such as a transmission speed. With the improved communication state, communication with a transmission speed higher than sound waves is achieved. Because the transmission speed is high, image data and sound data collected by the underwater drone 1 are transmitted in a short time. In addition, the responsive performance of the underwater drone 1 with respect to remote control is improved, and thus the operability of a user, that is, usability is improved. It is to be noted that although FIG. 3 illustrates an example in which the underwater drone 1 moves away in a depth direction, the underwater drone 1 may move away in a horizontal direction. In this case, the underwater drone 1 is made closer to the ship 300 in a horizontal direction.

<Processing Steps Executed by Underwater Drone 1>

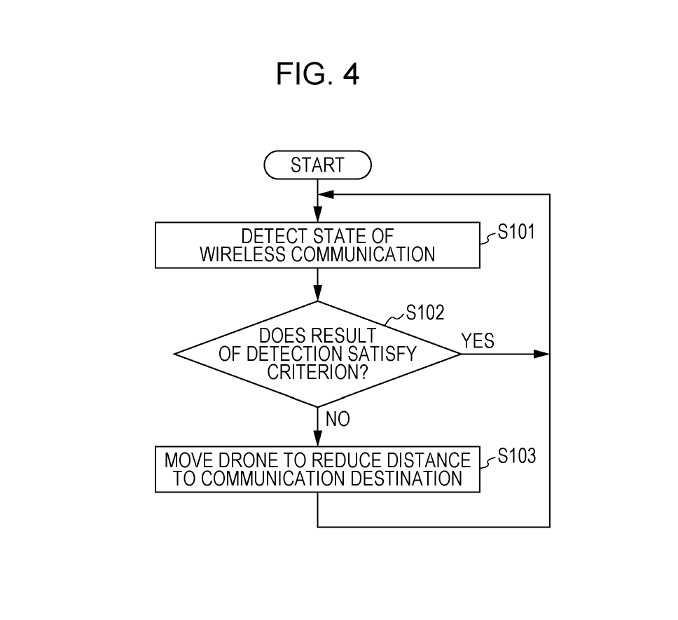

Next, the processing steps executed by the underwater drone 1 according to this exemplary embodiment will be described. FIG. 4 is a flowchart illustrating an example of processing steps executed by the movement controller 102 according to the first exemplary embodiment. The movement controller 102 repeatedly executes the processing of the flowchart illustrated in FIG. 4. In the case of this exemplary embodiment, the flowchart illustrated in FIG. 4 is executed every time a predetermined time elapses.

First, the movement controller 102 detects the state of wireless communication (step 101). In the case of this exemplary embodiment, a result of the detection is given as one of three-level evaluation values. Next, the movement controller 102 determines whether or not the result of the detection satisfies the criterion (step 102). For instance, it is determined whether or not the evaluation value has become “unfavorable state”.

When a negative result is obtained in step 102, the movement controller 102 causes the underwater drone 1 to move closer to the communication device 301 which is a communication destination (step 103). For instance, the movement controller 102 causes the underwater drone 1, which has a worsened communication state due to too large depth (the distance is 10 m), to surface, and reduces the distance between the underwater drone 1 and the communication device 301 in the ship 300. The reduced distance improves the communication situation. When an affirmative result is obtained in step 102, the flow for the movement controller 102 returns to step 101 with the current movement maintained.

As described above, the controller 10 of the underwater drone 1 according to this exemplary embodiment is equipped with the radio wave communicator 15 that transmits and receives radio waves with a higher propagation speed underwater than sound waves, and the controller 10 controls the distance between the underwater drone 1 and the communication device 301 as a communication partner according to a successively changing state of wireless communication. Specifically, when the state of wireless communication has worsened, the underwater drone 1 is moved closer to the communication device 301.

Thus, both expansion of the operating range and a high transmission speed are achieved compared with the case where the distance between the another communication device 301 and the underwater drone 1 is not controlled according to the state of wireless communication. More specifically, the underwater drone 1 located at a place far away from the base station 400 is remotely operated with communication via radio waves having a high transmission speed maintained.

It is to be noted that when the relay function is not provided, before communication via radio waves becomes impossible, no avoidance operation is executed, and the communication becomes impossible. Also, once communication becomes impossible, communication cannot be recovered, and the operation of the underwater drone 1 is hindered.

For instance, for fishing, inspection of marine facilities or leisure, remote control application of the underwater drone 1 in a shallow water area is assumed. As described above, due to a higher transmission speed of radio waves, the operability of a user is improved compared with the case where the underwater drone 1 is remotely controlled using only sound waves regardless of the depth. Meanwhile, for the purpose of avoiding an underwater obstacle such as a structure or a terrain, or due to the effect of stream of water, the underwater drone 1 may be moved to a deep water area where radio waves do not reach, or a place away in a horizontal direction.

However, with the underwater drone 1 according to this exemplary embodiment, when the state of wireless communication fails to satisfy the criterion, movement of the underwater drone 1 is controlled so that the underwater drone 1 is moved closer to the ship 300 (the communication device 301). Thus remote control is continued with a reception intensity and a high transmission speed maintained. Consequently, both expansion of the operating range of the underwater drone 1 and a high transmission speed are achieved, the operability and usability of a user who operates the underwater drone 1 by remote control are improved.

Although the determination processing as to the reception intensity and the transmission speed by the movement controller 102 is repeatedly executed at a predetermined execution interval in this exemplary embodiment, when the reception intensity or the transmission speed falls below the criterion, the execution interval for the determination processing may be reduced. In this case, the execution interval is increased when the distance between the underwater drone 1 and the ship 300 (the communication device 301) is close, and thus the consumption of a battery is reduced. In addition, since the frequency of execution of the determination processing increases in a situation where the necessity of movement control is high, the movement control to move the underwater drone 1 closer to the ship 300 (the communication device 301) is performed before communication becomes impossible.

Although processing to determine whether or not the movement control is to be executed is executed at a predetermined execution interval in this exemplary embodiment, the execution interval may be changed according to the speed of the underwater drone 1 in a direction in which the underwater drone 1 moves away from the ship 300 (the communication device 301). For instance, when the movement speed is low, change in the communication distance and the communication environment is small, and thus the execution interval may be increased, whereas when the movement speed is high, change in the communication distance and the communication environment is large, and thus the execution interval may be decreased.

In this exemplary embodiment, the case where communication between the underwater drone 1 and the base station 400 is performed via the communication device 301 mounted on the ship 300 has been described. However, the path through which communication is relayed is not limited to the above-described example. A specific example will be presented below.

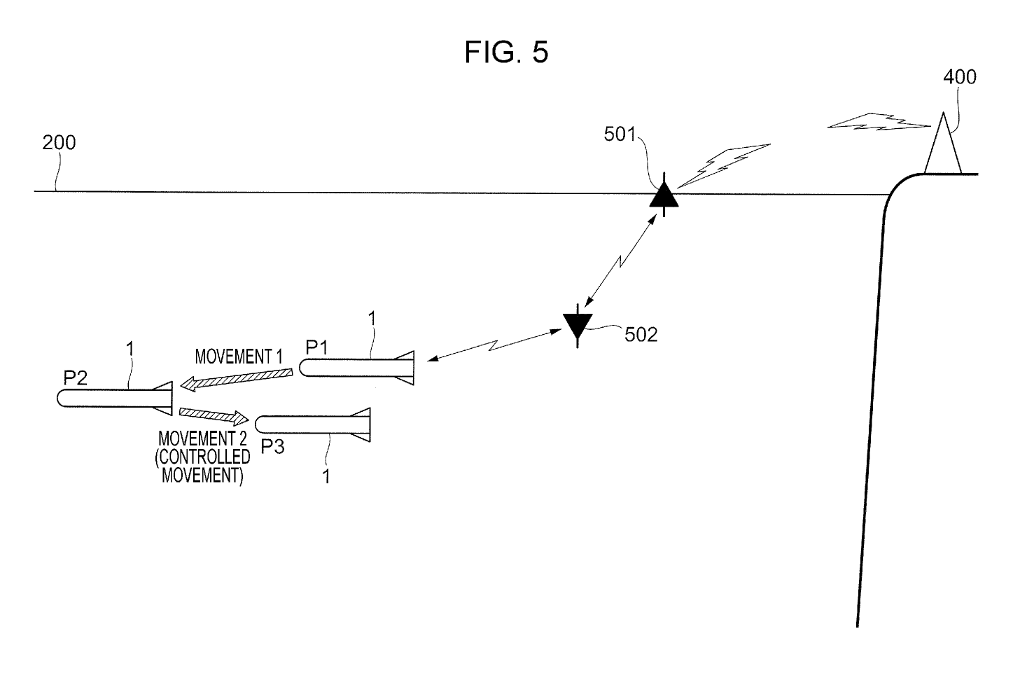

FIG. 5 is an illustration for explaining an example in which communication is relayed between the underwater drone 1 and the base station 400 via buoys 501, 502. In the case of FIG. 5, the underwater drone 1 and the buoys 501, 502 configurate an underwater communication system. Also, the buoys 501, 502 function as relay devices that relay communication of the underwater drone 1. The buoys 501, 502 differ from the underwater drone 1 in that a drive unit is not mounted. It is to be noted that the buoy 502 floats underwater. Incidentally, some type of buoy is fixed to the bottom of water. The bottom of water is not limited to the deepest bottom.

The buoy 501 is equipped with a communication device for in-air and a communication device for underwater. The communication device for in-air communicates with the base station 400 via radio waves, and the communication device for underwater communicates with the buoy 502 via very low frequency radio waves. The buoy 502 is equipped with one or multiple communication devices for underwater. The buoy 502 performs wireless communication with the underwater drone 1 and the buoy 501 using very low frequency radio waves.

In this manner, communication is relayed through multiple buoys, and the operating range of the underwater drone 1 is expanded not only to deep-sea area, but also in a plane direction. Although the distance between individual communication devices is limited to approximately 10 m, communication via radio waves achieve higher responsiveness than communication via sound waves does.

FIG. 5 illustrates the operation to be performed when the underwater drone 1 moves away too much in a horizontal direction. Also in this case, the operating range of the underwater drone 1 is limited within a range of approximately 10 m from the buoy 502 by the movement control performed by the movement controller 102. The number of buoys to be installed is easily increased, and thus it is also easy to expand the operating range of the underwater drone 1.

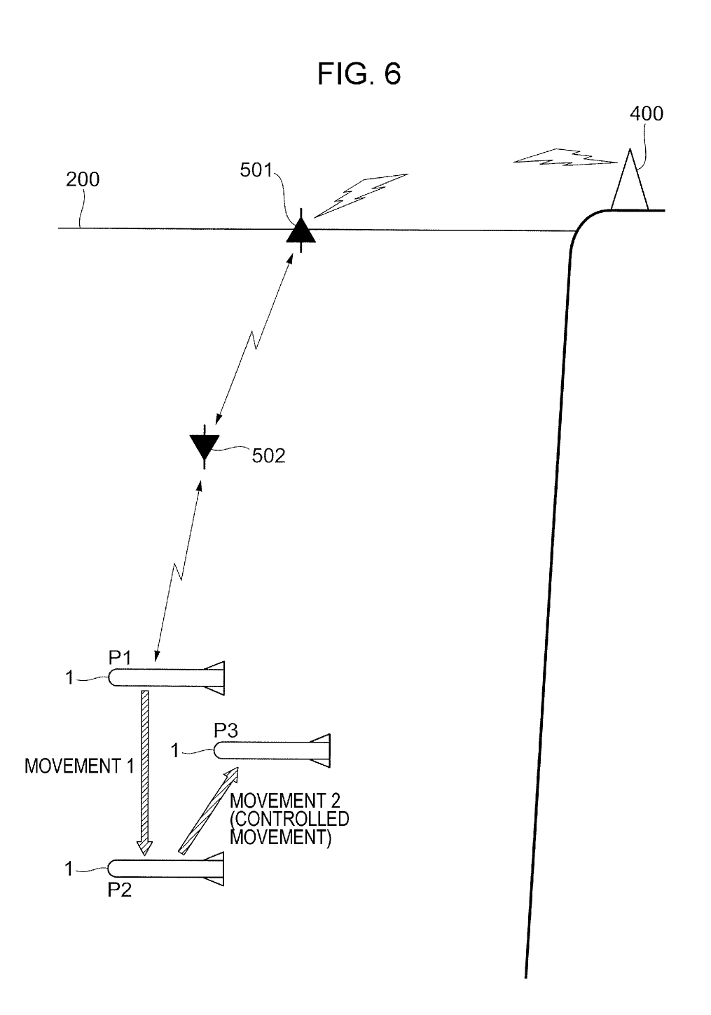

FIG. 6 is an illustration for explaining another example in which communication is relayed between the underwater drone 1 and the base station 400 via the buoys 501, 502. FIG. 6 illustrates the operation to be performed when the underwater drone 1 moves away too much in a depth direction. In the case of this example, the operating range of the underwater drone 1 is limited within a range of approximately 10 m from the buoy 502 by the movement control performed by the movement controller 102.

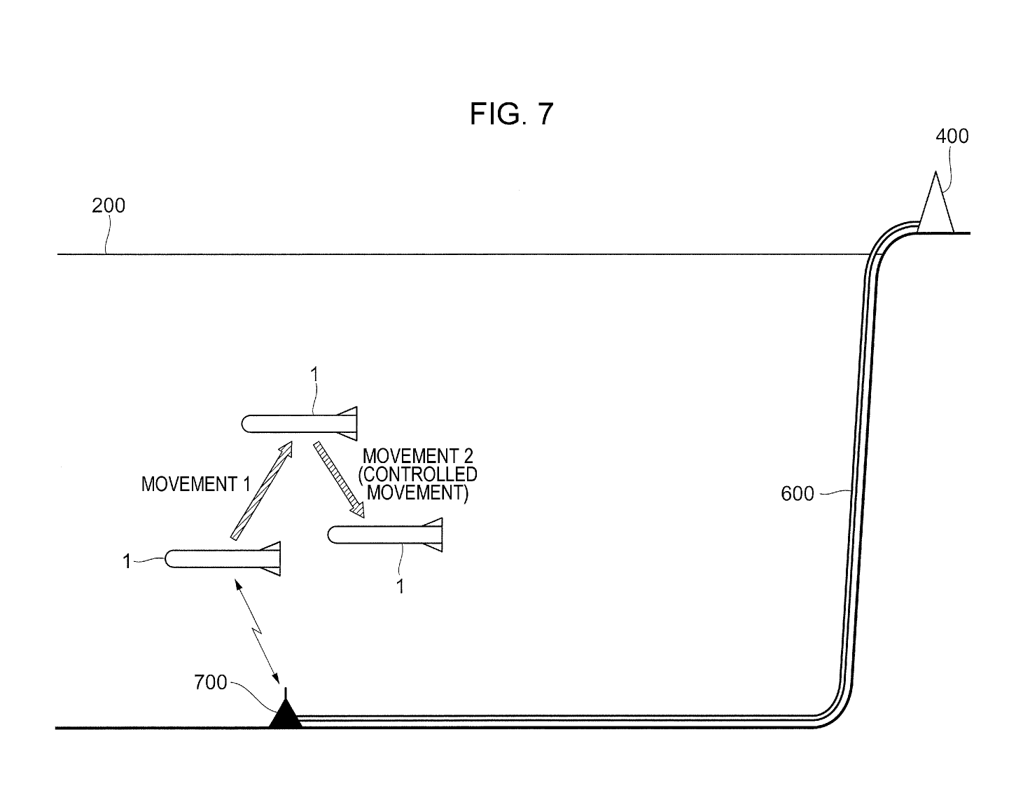

FIG. 7 is an illustration for explaining an example in which communication is relayed between the underwater drone 1 and the base station 400 via a relay station 700 coupled to the base station 400 by a cable 600. In the case of FIG. 7, the underwater drone 1, the cable 600 and the relay station 700 configurate an underwater communication system. Also, the relay station 700 functions as a relay device that relays communication of the underwater drone 1. FIG. 7 illustrates the operation to be performed when the underwater drone 1 moves away from the relay station 700 too much in a depth direction. It is to be noted that the cable 600 is an example of the wired communication path.

The relay station 700 here is fixed to the bottom of water, and thus information on the installation position is known. Thus, when the state of wireless communication deteriorates, the movement controller 102 utilizes control that moves the underwater drone 1 closer to the known installation position. Also, utilizing an optical cable for the cable 600 allows information to be transmitted at a high speed even when the underwater drone 1 is used at the bottom of water.

Also, a power source line is housed in the cable 600. Thus, in the case of the example of FIG. 7, power is wirelessly supplied to the underwater drone 1 to charge a secondary battery in the underwater drone 1. Recharging the secondary battery in the underwater drone 1 is repeated each time the remaining capacity thereof is decreased, and thereby the operating time of the underwater drone 1 is extended.

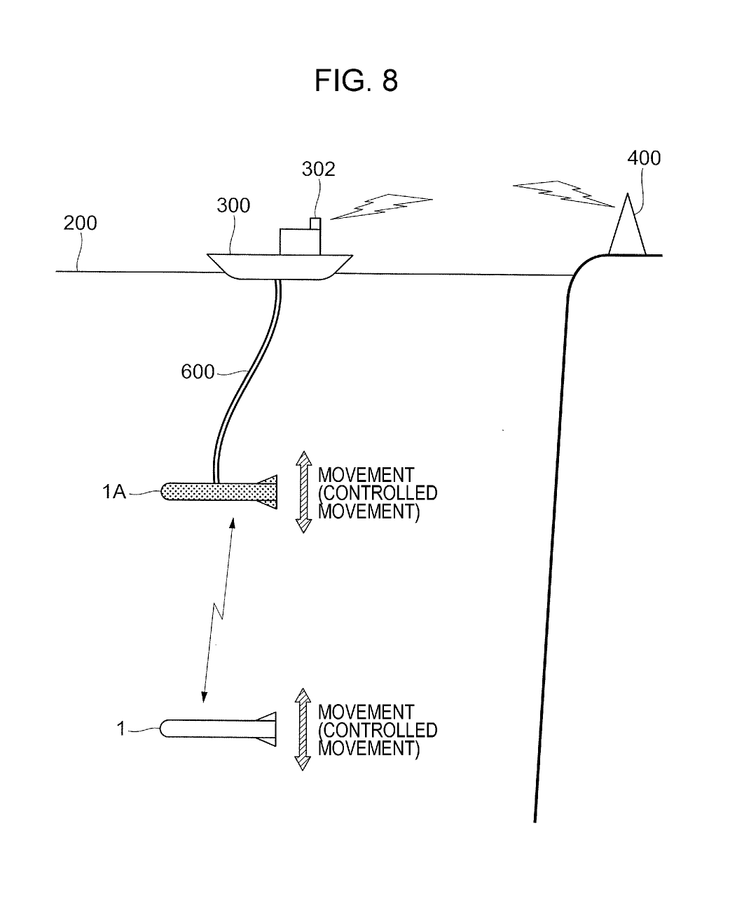

FIG. 3 illustrates an example in which the communication device 301, which relays underwater communication with the underwater drone 1, is fixed to the bottom of the ship 300. However, the relay device may be an underwater mobile body. FIG. 8 is an illustration showing an example in which the relay device is an underwater mobile body. In the case of FIG. 8, the underwater mobile body is an underwater drone 1A. The underwater drone 1A has the same configuration as the configuration of the underwater drone 1 described above. However, the underwater drone 1A illustrated in FIG. 8 is coupled to the ship 300 via the cable 600.

For this reason, the underwater drone 1A is equipped with not only a communication device for wireless communication with the underwater drone 1, but also a communication device for communication with the cable 600. Although the movement range of the underwater drone 1A is limited by the length of the cable 600, communication higher than wireless communication is achieved. In the case of FIG. 8, the underwater drones 1, 1A and the cable 600 configurate an underwater communication system. Also, the underwater drone 1A functions as a relay device that relays communication of the underwater drone 1.

In the case of this example, not only the underwater drone 1, but also the movement controller 102 mounted on the underwater drone 1A functioning as the relay device moves the position of a relevant underwater drone so that the state of wireless communication is not worsened. Consequently, compared with the above-described example, a high transmission speed is likely to be maintained even when the operating range of the underwater drone 1 is expanded. It is to be noted that the movement controller 102 does not have to be mounted on the underwater drone 1A as the relay device.

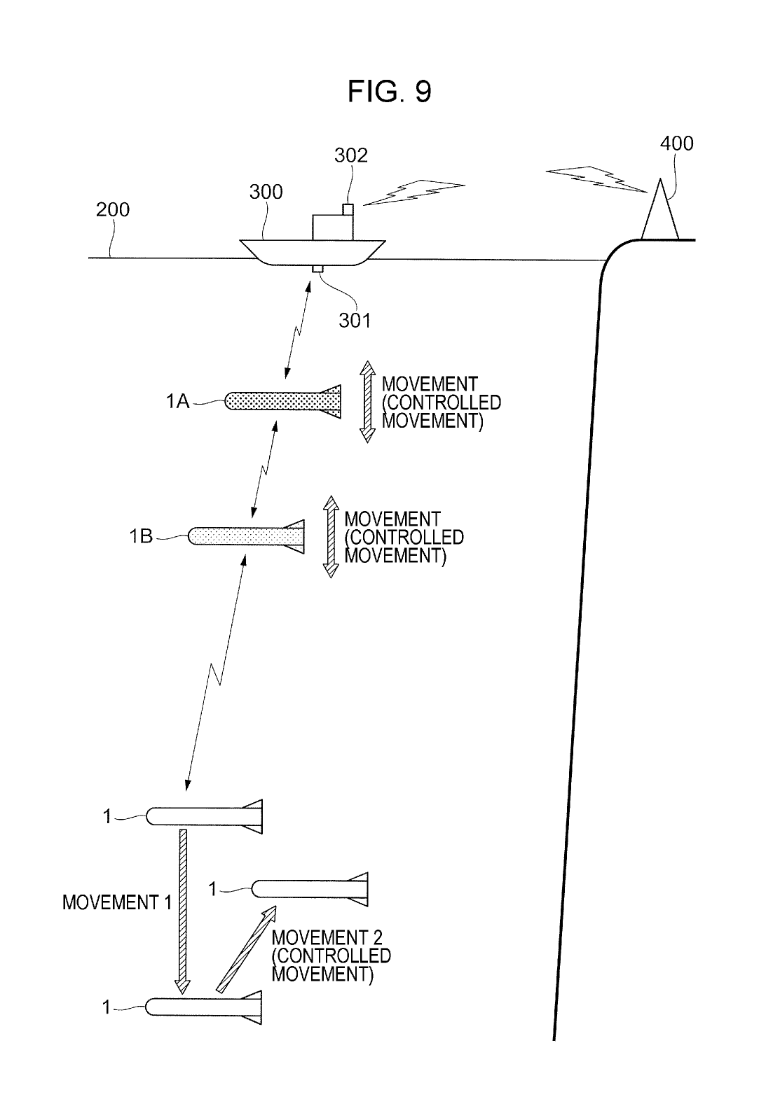

FIG. 9 is an illustration showing an operation example when the underwater drones 1A, 1B serving as relay devices has the same internal configuration of the underwater drone 1 serving as a terminal. The underwater drones 1A, 1B are an example of the second underwater mobile body. In the case of this example, the underwater drone 1A controls the distance between the communication device 301 provided at the bottom of the ship 300 and the underwater drone 1A according to the detected state of wireless communication. Also, the underwater drone 1A controls the distance between the underwater drone 1A and the underwater drone 1B according to the detected state of wireless communication.

The underwater drone 1B controls the distance between the underwater drone 1B and the underwater drone 1A according to the detected state of wireless communication. Also, the underwater drone 1B controls the distance between the underwater drone 1B and the underwater drone 1 according to the detected state of wireless communication. The underwater drone 1 as a terminal controls the distance to the underwater drone 1B which is a communication destination of the underwater drone 1, according to the detected state of wireless communication.

FIG. 9 illustrates the manner in which the underwater drone 1 surfaces closer to the underwater drone 1B because the underwater drone 1 as a terminal moves away too much in a depth direction. This operation is executed not only in the underwater drone 1 but also in the underwater drones 1A and 1B. As in this example, the underwater drones as relay devices work in coordination with each other to adjust the positional relationship therebetween, and the operating range is thereby flexibly changed. It goes without saying that a high transmission speed of radio waves is also maintained.

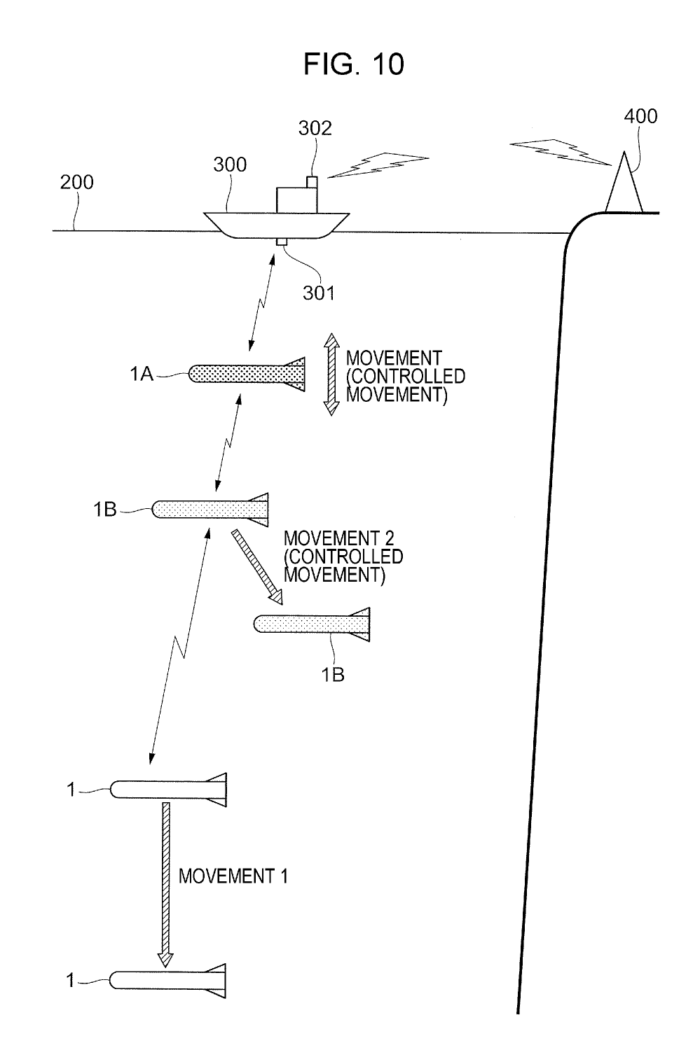

Although the underwater drone 1 as a terminal approaches the underwater drone 1B which is a relay device in FIG. 9, the underwater drones 1A and 1B which function as relay devices may move. FIG. 10 is an illustration showing an example in which the underwater drone 1B serving as a relay device approaches the underwater drone 1 serving as a terminal. In other words, the state of wireless communication in the underwater drone 1 is improved by extending the distance of the relay interval. The underwater drones 1, 1A and 1B, which configurate the underwater communication system, control the mutual positional relationship by working in coordination with each other, thereby expanding the operating range of the underwater drone 1 as a terminal.

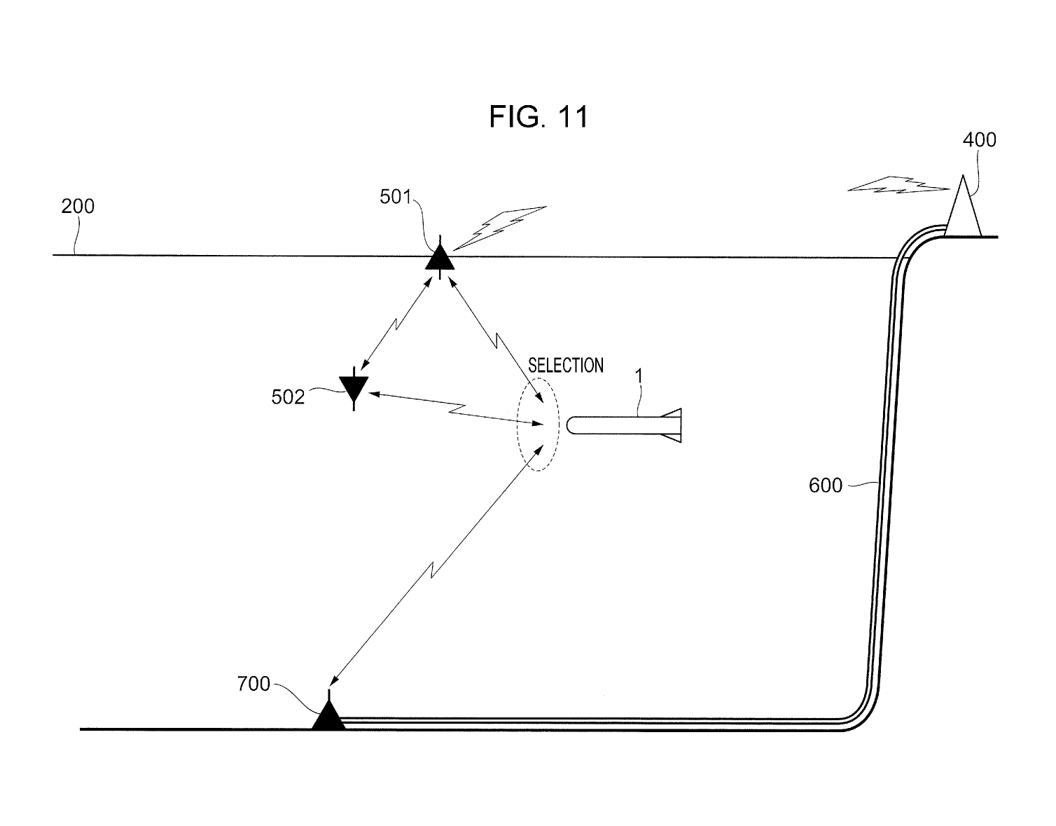

In the above-described example, one candidate is present for a communication destination of the underwater drone. However, in practical operation, multiple candidates may be present. In this case, the underwater drone 1 has to determine a communication destination. FIG. 11 is an illustration for explaining a case where multiple candidates for a communication destination are present as an object to be controlled as to positional relationship around the underwater drone 1.

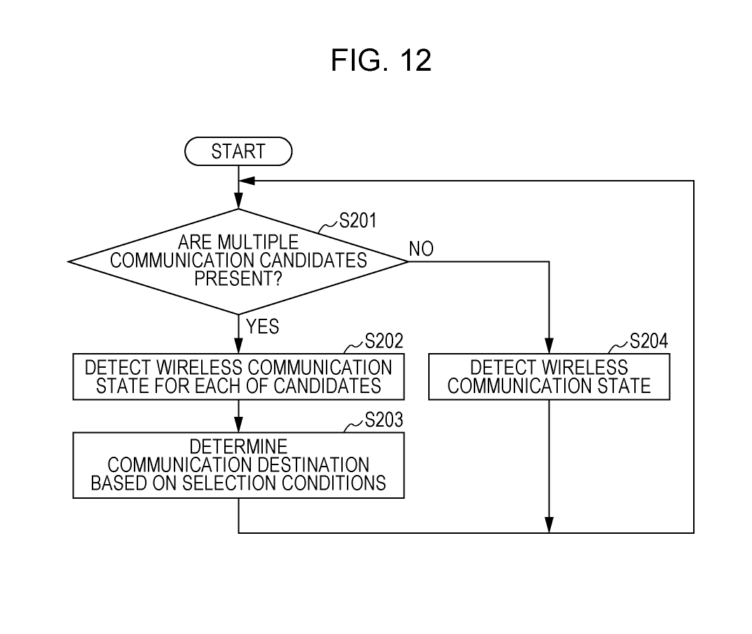

In the case of FIG. 11, the underwater drone 1 has a wireless communication path between the buoys 501, 502 and the relay station 700 installed at the bottom of water. In this case, the movement controller 102 of the underwater drone 1 determines a communication destination by the following steps. FIG. 12 is a flowchart illustrating an example of steps executed for determining a communication destination by the movement controller according to this exemplary embodiment. The movement controller 102 repeatedly executes the processing of the flowchart illustrated in FIG. 12. In the case of this exemplary embodiment, the flowchart illustrated in FIG. 12 is executed every time a predetermined time elapses.

First, the movement controller 102 determines whether or not multiple communication candidates are present (step 201). The movement controller 102 counts the number of communication candidates using the identification number or the like of a partner destination attached to successfully established communication. When the counted number is one, one candidate is present, and when the counted number is greater than one, multiple candidates are present.

When an affirmative result is obtained in step 201, that is, when multiple candidates are present, the movement controller 102 detects the state of wireless communication for each of the candidates (step 202). Subsequently, the movement controller 102 determines a communication destination of the underwater drone 1 from the multiple candidates based on selection conditions (step 203).

For instance, the movement controller 102 compares results of the detection for individual and determines a candidate in the best communication state to be a communication destination. It is to be noted that the transmission speeds or the reception intensities, which are part of information on the state of wireless communication, may be compared and a candidate having the highest transmission speed or a candidate having the greatest reception intensity may be determined to be a communication destination. Also, when communication path information is utilized, a candidate located on the upstream side may be determined to be a communication destination. The number of hop is decreased by determining a candidate located on the upstream side to be a communication destination, and the transmission speed in the entire path is increased. Anyway, the movement controller 102 controls the distance between the underwater drone 1 and the determined communication destination.

On the other hand, when a negative result is obtained in step 201, that is, when just one candidate is present, the movement controller 102 detects the state of wireless communication of the one candidate (step 204).

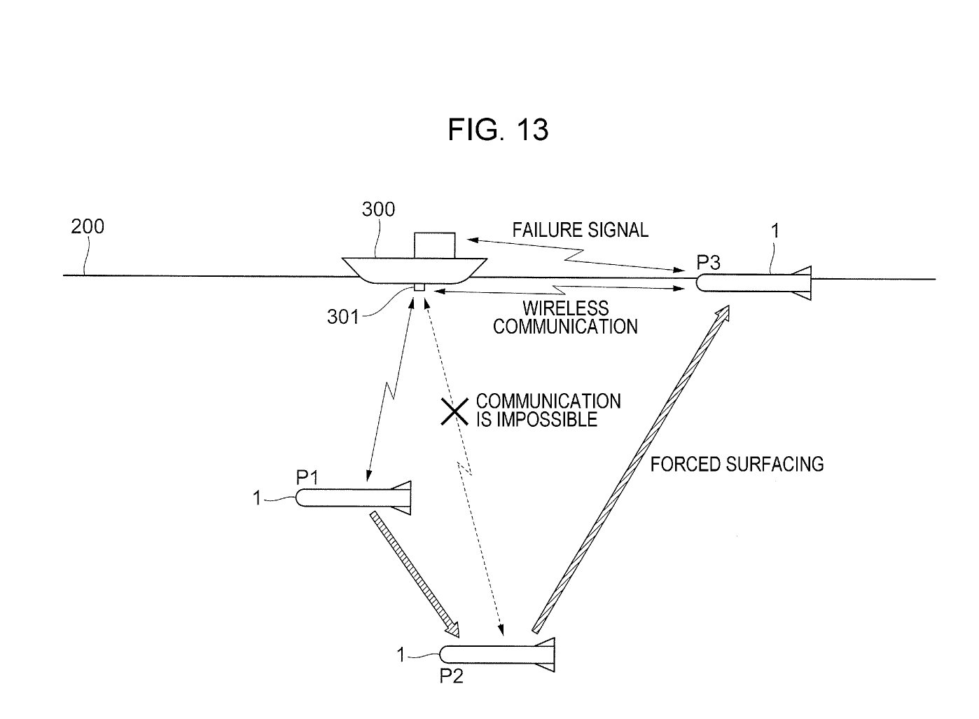

In the above-described exemplary embodiment, wireless communication between the communication device 301 and the underwater drone 1 is maintained by the function of the movement controller 102. However, in practical use, communication may become impossible. FIG. 13 is an illustration for explaining a function provided in case communication becomes impossible.

When communication is not recovered even by the movement control performed by the movement controller 102, the movement controller 102 moves to a predetermined depth or position, and performs control to attempt communication by the radio wave communicator 15. FIG. 13 illustrates a water surface 200 as an example of the predetermined depth or position. The predetermined depth or position may be on a water surface or in water as long as the position is for re-establishing communication.

The movement here may be movement in a horizontal direction, or movement in the surfacing direction or the descending direction. For instance, when a communication device as a communication destination is installed at the bottom of water or at a position deeper than the underwater drone, the underwater drone may be moved in the descending direction for the purpose of reducing the communication distance to the underwater drone. The predetermined position is not necessarily one position.

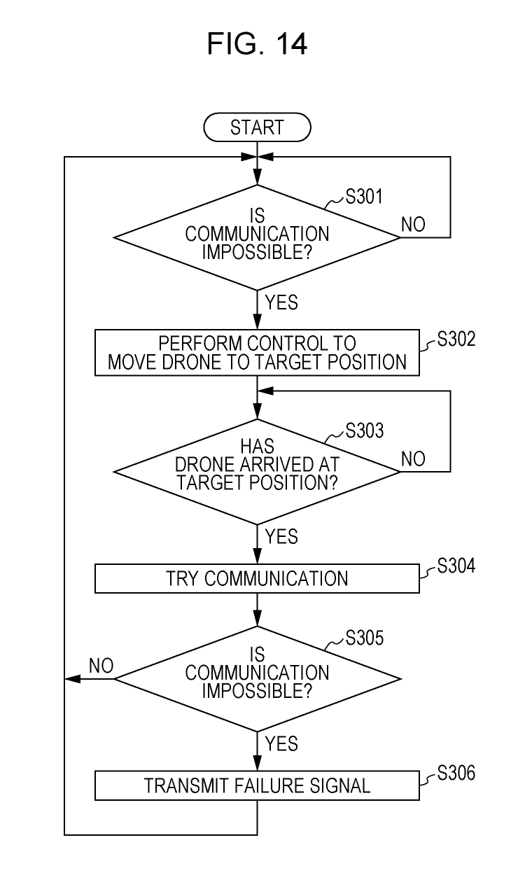

Next, an example of the detail of the control performed by the movement controller 102 will be described. FIG. 14 is a flowchart illustrating an example of processing steps executed by the movement controller 102 for recovering communication. First, the movement controller 102 determines whether or not communication by the radio wave communicator 15 is impossible (step 301).

As long as a negative result is obtained in step 301, the movement controller 102 executes the operation illustrated in FIG. 14, for instance. When an affirmative result is obtained in step 301, the movement controller 102 controls the steerer 19 and the propeller 20 to move the underwater drone 1 to a predetermined destination position (step 302). For the movement, various sensors mounted on the underwater drone 1 and information on movement path, and position information from a position detection system may be used.

The movement operation in step 302 is continued until arrival to a destination position is checked (until an affirmative result is obtained) in step 303. When an affirmative result is obtained in step 303, the movement controller 102 stops the movement and tries to establish communication by the radio wave communicator 15 (step 304). When communication is resumed, the underwater drone 1 returns to communication control.

In the case where impossible communication is caused by the radio wave communicator 15, even when the underwater drone 1 is moved to a predetermined destination position, communication is not recoverable. Thus, the movement controller 102 determines whether or not communication is impossible after an attempt to establish communication (step 305). When a negative result is obtained in step 305, communication is resumed, and thus the flow for the communication controller 102 returns to step 301.

On the other hand, when an affirmative result is obtained in step 305, the movement controller 102 commands a failure signal transmitter (not illustrated) to transmit a failure signal (step 306). The failure signal is a one-way signal that is transmitted from the underwater drone 1, for instance, a beacon. Although the flow returns to step 301 after transmission of a failure signal here, transmission of a failure signal may be continued.

In the above-described example, the movement controller 102 mounted on the underwater drone 1 performs control to move the underwater drone 1 closer to the device at a communication destination. However, the movement controller 102 may transmit a control signal to a relay device as a communication destination instead of the underwater drone 1 to move the relay device closer to the underwater drone 1. Also such control allows the distance between the relay device at a communication destination and the underwater drone 1 to be reduced, and the state of wireless communications is improved.

### Other Exemplary Embodiments

In the above-described exemplary embodiment, the case where radio waves are used for underwater wireless communication has been described. However, light may be used for wireless communication. In this case, an optical communicator configurated by a light emitter and a light receiver is mounted on the underwater drone. As communication light, for instance, visible light is used. As the light emitter, for instance, an LED, which emits blue light absorbed less underwater, is used.

Although one unit of the radio wave communicator 15 is mounted on the underwater drone in the above-described exemplary embodiment, both the radio wave communicator and the optical communicator may be mounted on the underwater drone, and one of the communicators may be properly used according to the usage environment. In addition, a sound wave communicator that transmits and receives sound waves with a long communication distance may also be mounted on the underwater drone, and may be properly used according to the usage environment. It is to be noted that in the case of sound waves, a control technique for reducing the distance between the underwater drone and the relay device at a communication destination may be applied to improve reduced reception sensitivity.

Although one unit of the radio wave communicator 15 is mounted on the underwater drone in the above-described exemplary embodiment, multiple units of the radio wave communicator 15 may be mounted on the underwater drone. For the radio wave communicator and the optical communicator described above, multiple units of each communicator may be mounted. When multiple units of a communicator are prepared for one communication system, an alternative communicator may be used as a replacement for a failed communicator, or multiple units of a communicator may be used for one communication system to increase the amount of communication per unit time.

Although the illuminator 16 and the imaging camera 17 are mounted on the underwater drone 1 according to the above-described exemplary embodiments, these components may not be mounted. It is to be noted that an underwater microphone may be mounted along with the imaging camera 17 or instead of the imaging camera 17. When an imaging camera is not used, the illuminator 16 does not have to be mounted. The underwater drone 1 according to the above-described exemplary embodiments may include, for instance, a robot arm, a fixing tool, or equipment needed depending on the application.

Although the underwater wireless communication in the underwater drone as an unmanned underwater mobile body has been described as an example in the above-described exemplary embodiments, the invention may be applicable to underwater wireless communication in a manned underwater mobile body, for instance, a mobile body to be boarded by one to three crews.

Although the case where the underwater drone changes the moving direction by the steerer has been explained in the above-described exemplary embodiments, in the case of a robot for underwater work, the moving direction may be changed by a caterpillar or another drive unit.

Although the exemplary embodiments of the invention have been described so far, the technical scope of the invention is not limited to the range described in the exemplary embodiments. It is apparent from the description of the claims that embodiments obtained by making various modifications or improvements to the exemplary embodiments are also included in the technical scope of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An underwater mobile body comprising:
a communication unit that performs underwater wireless communication with a relay device;
a detection unit that detects a state of wireless communication between the relay device and the underwater mobile body; and
a control unit that controls a positional relationship between the relay device and the underwater mobile body so that a result of detection by the detection unit satisfies a predetermined criterion.

2. The underwater mobile body according to claim 1,
wherein when the result of detection fails to satisfy the predetermined criterion, the control unit causes the underwater mobile body to move closer to the relay device.

3. The underwater mobile body according to claim 2,
wherein when a position of the relay device is known, the control unit causes the underwater mobile body to move closer to the position.

4. The underwater mobile body according to claim 1,
wherein when the result of detection fails to satisfy the predetermined criterion, the control unit causes the underwater mobile body to move in a direction in which the result of detection is improved.

5. The underwater mobile body according to claim 1,
wherein when a plurality of units of the relay device are present around the underwater mobile body, the control unit determines one of the plurality of units of the relay device to be a communication destination based on a plurality of pieces of the result of detection.

6. The underwater mobile body according to claim 5,
wherein the control unit determines one of the plurality of units of the relay device to be a communication destination based on the plurality of pieces of the result of detection and communication path information.

7. An underwater mobile body comprising:
a communication unit that performs underwater wireless communication with a relay device; and
a control unit that, when communication by the communication unit is not possible, causes the underwater mobile body to move for establishing communication, then tries to start communication.

8. The underwater mobile body according to claim 7,
wherein the control unit causes the underwater mobile body to move to a predetermined depth or position.

9. The underwater mobile body according to claim 8,
wherein when communication is not recovered even after the movement to the predetermined depth or position, the control unit causes a failure signal transmitter to transmit a failure signal.

10. An underwater communication system comprising:
an underwater mobile body that moves underwater; and
one or a plurality of relay devices that perform wireless communication with the underwater mobile body directly or indirectly,
wherein the underwater mobile body includes
a communication unit that performs underwater wireless communication with the one or plurality of relay devices,
a detection unit that detects a state of wireless communication between the one or plurality of relay devices and the underwater mobile body, and
a control unit that controls a positional relationship between the one or plurality of relay devices and the underwater mobile body so that a result of detection by the detection unit satisfies a predetermined criterion.

11. The underwater communication system according to claim 10,
wherein at least one of the one or plurality of relay devices is mounted on one or a plurality of second underwater mobile bodies that move underwater.

12. The underwater communication system according to claim 11,
wherein the one or plurality of second underwater mobile bodies include a second underwater mobile body including:
a communication unit that performs underwater wireless communication with the underwater mobile body or the one or plurality of relay devices other than the second underwater mobile body;
a detection unit that detects a state of wireless communication between the second underwater mobile body and the underwater mobile body or the one or plurality of relay devices other than the second underwater mobile body; and
a control unit that controls a positional relationship between the one or plurality of relay devices other than the second underwater mobile body and the second underwater mobile body, and a positional relationship between the underwater mobile body and the second underwater mobile body so that a result of detection by the detection unit satisfies a predetermined criterion.

13. The underwater communication system according to claim 11,
wherein at least one of the one or plurality of second underwater mobile bodies are coupled to a wired communication path.

14. The underwater communication system according to claim 10,
wherein at least one of the one or plurality of relay devices is installed at a bottom of water, and is coupled to a base station via a wired communication path.

15. The underwater communication system according to claim 14,
wherein the underwater mobile body wirelessly receives power supplied from at least one of the one or plurality of relay devices.

16. The underwater communication system according to claim 10,
wherein at least one of the one or plurality of relay devices is mounted on a buoy installed on water or underwater.
